(19) United States
(12) Patent Application Publication
(10) Pub. No.: US 2021/0170266 A1
(43) Pub. Date: Jun. 10, 2021

(54) Neuro Puzzles

(71) Applicant: Neuro Puzzles, LLC, McKinney, TX (US)

(72) Inventor: Karen Shawe, McKinney, TX (US)

(21) Appl. No.: 16/704,246

(22) Filed: Dec. 5, 2019

(51) Int. Cl. A63F 9/10; A63F 3/04

(52) U.S. Cl. CPC A63F 9/10; G09B 17/00; A63F 3/0423

(57) ABSTRACT

An alternative to a traditional single solution puzzle is disclosed. Under the puzzle system of the present invention, each tab fits into each pocket, thereby allowing the user to build creatively rather than attempt to solve. The puzzle system of the present invention is useful for all, and it is optimal for young children, aging and cognitively impaired adults.

### BACKGROUND OF THE DISCLOSURE

### Technical Field of the Disclosure

The present disclosure relates generally to puzzle games and more particularly to an advanced design of a jigsaw puzzle having images on both sides ensuring double entertainment and frequent uses.

### Description of the Related Art

A puzzle is a game, or a problem that tests a person's caliber or knowledge. A puzzle or a word game is generally used as a source of entertainment. There are different categories of puzzles such as number puzzles, word search puzzles, crossword puzzles, relational puzzles, or logic puzzles. Each puzzle may come in many variations, having a number of small pieces shaped with interlocked and tile pieces. Usually each piece has a small part of a picture or a word marked on it. In a puzzle, the solver is expected to put the pieces together in a logical way for solving the problem and in order to arrive at the correct or fun solution of the problem. Finally, when completing the puzzle, it produces a complete picture or numbering. These types of puzzles can be served as an educational purpose too.

Several methods have been developed in the art for constructing a number puzzle or word search puzzle. Most common puzzles include a plurality of puzzle pieces configured to be assembled into a predetermined image. However, standard puzzles are often not optimal for young children or cognitively impaired adults who are incapable of solving the puzzle.

Another method discloses a puzzle having jigsaw pieces with verbiage thereon, such as letters or words. These pieces are assembled to form verbal expressions such as words, sentences, phrases, quotations, nursery rhymes, poems, stories or books. This puzzle may be designed for toddlers, children, young adults and adults who will assemble jigsaw puzzle pieces to complete a word, sentence or story, etc. However, these jigsaw puzzles are also not optimal for young children or cognitive impaired adults for the same reason.

Yet another method describes a puzzle that includes a base board on which a number of cutouts and the same number of puzzle pieces with shapes corresponding to the cutouts and images on both sides. Inserting these small pluralities of cut out pieces into the base board, the figure or numbering is completed easily. However, this type of puzzle doesn't create any patience, creativity or any eye hand coordination for the children.

All of the prior art puzzles described above have a single solution. Therefore, there is a need for a new type of puzzle for developing and improving creativity, eye hand coordination and patience of children as well as aging or cognitively impaired adults. Such a needed device would be a simple puzzle adaptable for varying physical and cognitive skill levels. Such would be an alternative to single solution puzzle. Such a puzzle would need a high level of performance skill to help the younger children, impaired, and aged people, and start developing their brain for achieving their goals. Further, such a puzzle would be available with a tab that would fit into any piece with a pocket and would be designed for both entertainment purpose as well as for cognitive development. The present embodiment overcomes shortcomings in the field by accomplishing these critical objectives.

### SUMMARY OF THE DISCLOSURE

To minimize the limitations found in the existing systems and methods, and to minimize other limitations that will be apparent upon the reading of the specifications, preferred embodiment of the present invention provides a neuro puzzle filled with fun, and provides an interactive and integrated learning approach that enables creativity and eye hand coordination.

The neuro puzzle comprises a plurality of puzzle pieces having at least one corner tab piece, at least one corner pocket piece, at least one edge tab piece, at least one edge pocket piece, at least one internal tab piece and at least one internal pocket piece. Each of the plurality of puzzle pieces includes a first side, a second side adjacent to the first side, a third side adjacent to the second side and parallel to the first side and a fourth side adjacent to the third side and first side and parallel to the second side. The plurality of puzzle pieces is engraved with a design. Each of the at least one corner tab piece includes at least two straight edge sides and at least two tab sides. The at least two tab sides includes a tab on each side. The at least one corner pocket piece includes at least two straight edge sides and at least two pocket sides. The at least two pocket sides includes a pocket on each side. The at least one edge tab piece includes one straight edge side and a tab on the other three sides. The at least one edge pocket piece includes one straight edge side and a pocket on the other three sides. The at least one internal tab piece includes a tab on each of the four sides of the puzzle piece. The at least one internal pocket piece includes a pocket on each of the four sides puzzle piece. The neuro puzzle is arranged by fitting the tabs on the plurality of puzzle pieces with the pockets on the plurality of puzzle pieces thereby establishing a puzzle without a single solution.

A first objective of the present embodiment is to provide a puzzle for developing and improving creativity, flexible resilient thinking, and patience of children, cognitively impaired people, and aged people.

A second objective is to develop fine motor skills of children, cognitively impaired adults and aging people.

A second objective of the present embodiment is to provide a puzzle that is simple and adaptable for varying physical and cognitive skill levels.

A third objective of the present embodiment is to provide a puzzle that is an alternative to single solution puzzle.

A fourth objective of the present embodiment is to provide a puzzle that allows young children and aged people to improve a high level of performance skill and would enhance brain development.

Another objective of the present embodiment is to provide a puzzle that can develop special reasoning of children, cognitively impaired people, and aged people.

Yet another objective of the present embodiment is to provide a puzzle that is designed for both entertainment as well as serious thinking puzzle.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 illustrates a top view of a neuro puzzle in accordance with the preferred embodiment of the present invention;

FIG. 2A illustrates a top view of at least one corner tab piece of the neuro puzzle in accordance with the preferred embodiment of the present invention;

FIG. 2B illustrates a top view of at least one corner pocket piece of the neuro puzzle in accordance with the preferred embodiment of the present invention;

FIG. 2C illustrates a top view of at least one edge tab piece of the neuro puzzle in accordance with the preferred embodiment of the present invention;

FIG. 2D illustrates a top view of at least one edge pocket piece of the neuro puzzle in accordance with the preferred embodiment of the present invention;

FIG. 2E illustrates a top view of at least one internal tab piece of the neuro puzzle in accordance with the preferred embodiment of the present invention;

FIG. 2F illustrates a top view of at least one internal pocket piece of the neuro puzzle in accordance with the preferred embodiment of the present invention;

FIG. 3A illustrates a top view of a first step to arrange a plurality of puzzle pieces in accordance with the preferred embodiment of the present invention;

FIG. 3B illustrates a top view of a second step to arrange the plurality of puzzle pieces in accordance with the preferred embodiment of the present invention;

FIG. 3C illustrates a top view of a third step to arrange the plurality of puzzle pieces in accordance with the preferred embodiment of the present invention; and

FIG. 3D illustrates a top view of a fourth step to arrange the plurality of puzzle pieces in accordance with the preferred embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized, and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term ‘about” means+/−5% of the recited parameter. All embodiments of any aspect of the invention can be used in combination, unless the context clearly dictates otherwise.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

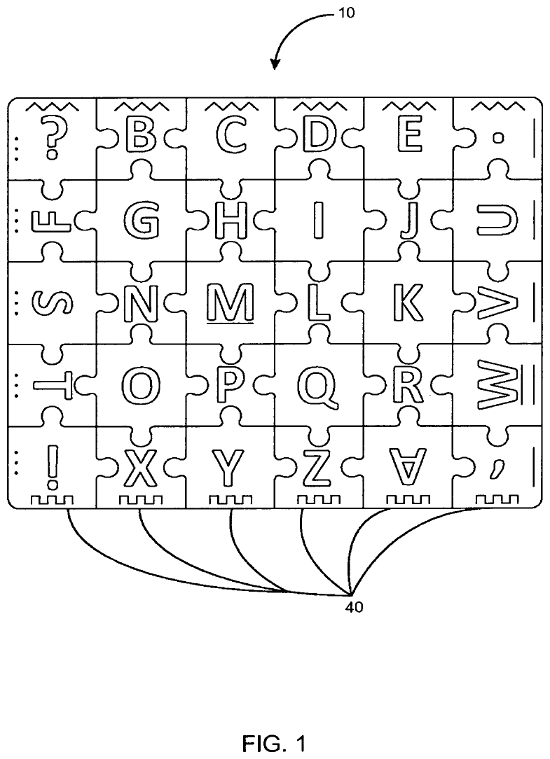

Referring to FIG. 1, a top view of a neuro puzzle 10 in accordance with the present invention is illustrated. The neuro puzzle 10 of the present invention provides a puzzle filled with fun, interactive and integrated learning approach that enables creativity and eye hand coordination. The neuro puzzle 10 is helpful for children, rehab patients who requires recovery from brain, stroke, hand injuries or other similar rehabilitation, people who desire to maintain neural connections or those patients with dementia, Alzheimer's or other certain types of onset diseases (Parkinson's etc.). The neuro puzzle 10 of the present application has no right answers. The unique design of the neuro puzzle 10 is made to stimulate neuronal activity, which may improve memory. The present invention further is made to encourage and improve memory, cognitive encouragement, and physical dexterity, amongst many other benefits.

The neuro puzzle 10 comprises a plurality of puzzles pieces 40 having at least one corner tab piece 12, at least one corner pocket piece 14, at least one edge tab piece 16, at least one edge pocket piece 18, at least one internal tab piece 20 and at least one internal pocket piece 22. Each of the plurality of puzzle pieces 40 includes four sides, for example a first side (not shown), a second side (not shown) adjacent to the first side, a third side (not shown) adjacent to the second side and parallel to the first side and a fourth side (not shown) adjacent to the third side and first side and parallel to the second side. The plurality of puzzle pieces 40 is engraved with a design 36. The design 36 on the plurality of puzzle pieces 40 is selected from the group consisting of a letter, a number, and an animal.

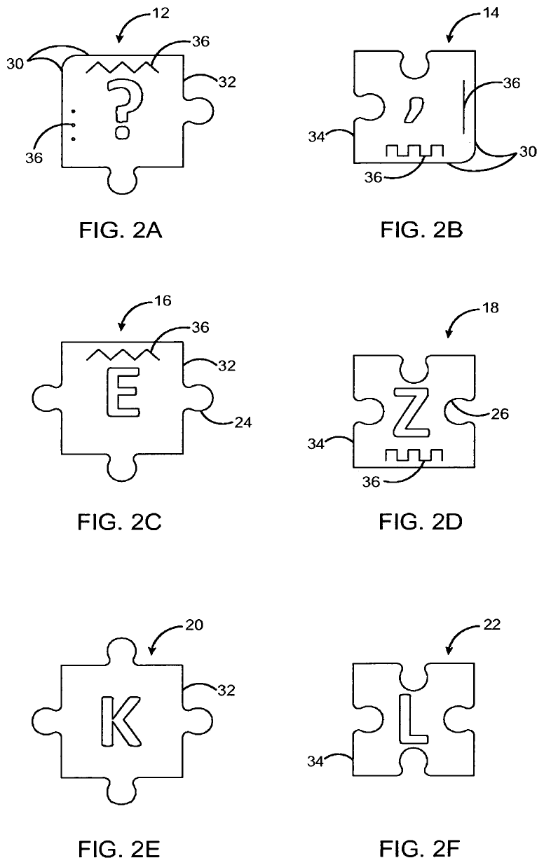

FIGS. 2A to 2F illustrates the plurality of puzzles pieces 40. The at least one corner tab piece 12 is illustrated in FIG. 2A. Each of the at least one corner tab piece 12 includes at least two straight edge sides 30 and at least two tab sides 32 (element 32 points to one of the 2 tab sides shown in FIG. 2A). The at least two tab sides 32 includes a tab 24 on each side. For example, the at least one corner tab piece 12 includes a tab 24 (labelled on FIG. 2C) on the first side and the second side, a straight edge on the third side and the fourth side as in FIG. 2A.

The at least one corner pocket piece 14, as illustrated in FIG. 2B, includes at least two straight edge sides 30 and at least two pocket sides 34. The at least two pocket sides 34 (element 34 points to one of the 2 pocket sides shown in FIG. 2B) includes a pocket 26 on each side. The at least one corner pocket piece 14, for example, may include a pocket 26 on the first side and the second side, a straight edge on the third side and the fourth side.

The at least one edge tab piece 16, as illustrated in FIG. 2C, includes one straight edge side 30 and a tab side 32 on the other three sides. For example, the at least one edge tab piece 16 includes a tab 24 on the first side, the second side, and the third side. The at least one edge pocket piece 18, as illustrated in FIG. 2D, includes one straight edge side 30 and a pocket 26 on the other three sides. The at least one internal tab piece 20 is illustrated in FIG. 2E. The at least one internal tab piece 20 includes a tab 24 on each of the four sides of the puzzle piece. The at least one internal pocket piece 22, as illustrated in FIG. 2F, includes a pocket 26 on each of the four sides puzzle piece. The neuro puzzle 10 is arranged utilizing the plurality of puzzle pieces 40 as illustrated in FIG. 1. The tabs on the plurality of puzzle pieces 40 fit with the pockets on the plurality of puzzle pieces 40 thereby establishing a puzzle without a single solution.

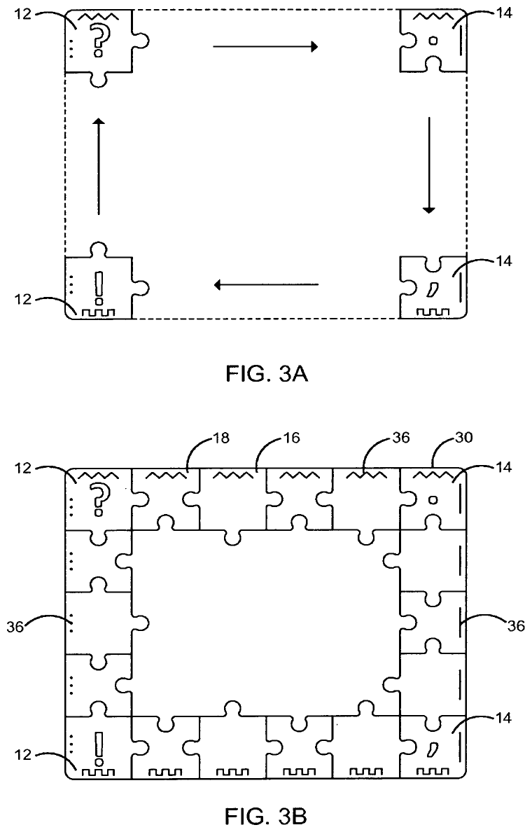

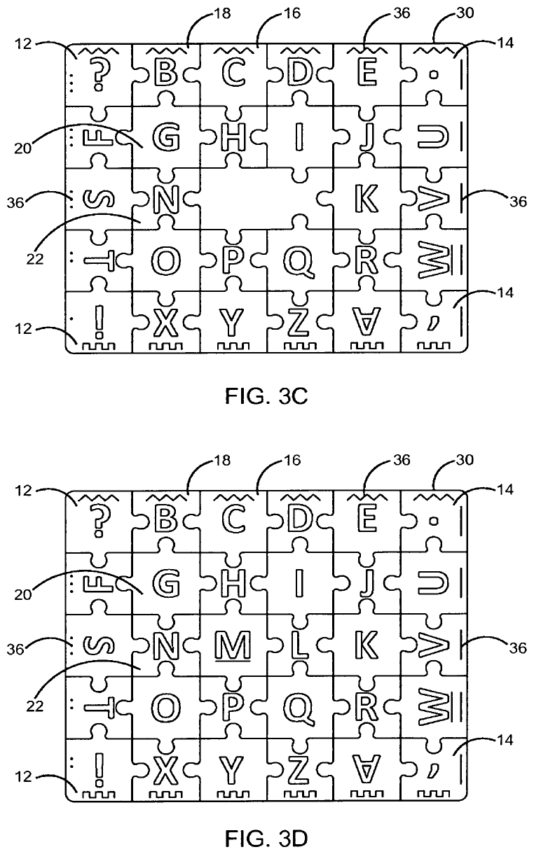

FIGS. 3A-3D illustrate a method for arranging the plurality of puzzle pieces to solve the puzzle. The first step involves selecting and positioning at least one corner tab piece 12 or at least one corner pocket piece 14 as illustrated in FIG. 3A. Then positioning the at least one edge tab piece 16 and the at least one edge pocket piece 18 with the at least one corner tab piece 12 or at least one corner pocket piece 14 such that the similar design 36 on each of the plurality of puzzle pieces 40 are arranged in a row. The at least one edge tab piece 16 and the at least one edge pocket piece 18 are aligned such that the puzzle pieces 40 with the same design 36 are arranged in a line with the tabs 24 of each of the plurality of puzzle pieces 40 fitted with the pockets 26 of the adjacent puzzle pieces 40. Thus, the outer layer of the neuro puzzle 10 is arranged as illustrated in FIG. 3B. Then the inner layer is arranged utilizing the at least one internal tab piece 20 and at least one internal pocket piece 22 as illustrated in FIGS. 3C and 3D.

The thickness of the plurality of puzzle pieces 40 can preferably be of 0.25 inch, and have a size selected from the group consisting of: 2 inches by 2 inches, 3 inches by 3 inches, and 4 inches by 4 inches, thereby meeting established non-choking standards for children. The plurality of puzzle pieces 40 is made of a material selected from a group consisting of: bamboo, 0.25-inch-thick high-density polyethylene resin and wood. These materials enable easy cleaning of the neuro puzzle.

The shape configuration of each of the plurality of puzzle pieces 40 is unique because any tab fits into any pocket so that there is 100% success rate. Further, the plurality of puzzle pieces 40 can be customized with photos, colors, words, and sizes depending on the special needs of the user. The neuro puzzle 10 can be used at home for adults and children of an age and can also be used in by doctors and therapy offices around the world for cognitive and physical therapy.

The neuro puzzle 10 offers a solution to the issues and challenges that traditional puzzles often have on adults and children of all ages with cognitive or physical challenges. The easy custom design of the puzzle increases both the cognitive and physical health of the users while completing the puzzle which helps with memory and physical dexterity.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. (canceled)

2. A puzzle comprising:
a. a plurality of puzzle pieces;
b. the puzzle pieces have between zero and 4 pockets and the puzzle pieces have between zero and 4 tabs;
c. wherein every tab fits with every pocket thereby establishing a puzzle without a single solution;
d. the plurality of puzzle pieces have a first side, a second side adjacent to the first side, a third side adjacent to the second side and parallel to the first side, and a fourth side adjacent to the third and first sides and parallel to the second side;
e. each side has a shape selected from the group consisting of a single pocket, a single tab, and a straight edge;
f. the plurality of puzzle pieces are made of bamboo.

3. The puzzle of claim 2, wherein the plurality of puzzle pieces include: at least one corner pocket piece, the corner pocket piece having a pocket on the first side and a pocket on the second side, a straight edge on the third side, and a straight edge on the fourth side.

4. The puzzle of claim 2, wherein the plurality of puzzle pieces include: at least one corner tab piece, the corner tab piece having a tab on the first side and a tab on the second side, a straight edge on the third side and a straight edge on the fourth side.

5. The puzzle of claim 2, wherein the plurality of puzzle pieces include at least one edge tab piece, the edge tab piece having a tab on the first, second, and third sides.

6. The puzzle of claim 2, wherein the plurality of puzzle pieces include at least one edge pocket piece, the edge pocket piece has a pocket on the first side, the second side, and the third side, and a straight edge on the fourth side.

7. The puzzle of claim 2, wherein the plurality of puzzle pieces include at least one internal pocket piece, the internal pocket piece having a pocket on all four sides.

8. The puzzle of claim 2, wherein the plurality of puzzle pieces include at least one internal tab piece, the internal tab piece having a tab on all four sides.

9. The puzzle of claim 2, wherein the plurality of puzzle pieces are engraved with a design.

10. The puzzle of claim 9, wherein the design is selected from the group consisting of a letter, a number, and an animal.

11. The puzzle of claim 2, wherein the plurality of puzzle pieces are 0.25 inches thick, and the plurality of puzzle pieces have a size selected from the group consisting of 2 inches by 2 inches, 3 inches by 3 inches, and 4 inches by 4 inches, thereby meeting established non-choking standards for children.

12. The puzzle of claim 5, wherein the edge tab pieces and the edge pieces are engraved with a designated design.

13. (canceled)

14. A puzzle comprising:
a. a plurality of puzzle pieces;
b. the puzzle pieces have between zero and 4 pockets and the puzzle pieces have between zero and 4 tabs;
c. wherein every tab fits with every pocket thereby establishing a puzzle without a single solution;
d. the plurality of puzzle pieces have a first side, a second side adjacent to the first side, a third side adjacent to the second side and parallel to the first side, and a fourth side adjacent to the third and first sides and parallel to the second side;
e. each side has a shape selected from the group consisting of a single pocket, a single tab, and a straight edge;
f. the plurality of puzzle pieces are made of 0.25 inch thick high density polyethylene resin.

15. (canceled)
